(19) United States
(12) Patent Application Publication
(10) Pub. No.: US 2023/0001623 A1
(43) Pub. Date: Jan. 5, 2023

(54) METHOD AND INSTALLATION FOR MANUFACTURING AND TREATING STERILE PLASTIC CONTAINERS

(71) Applicant: KHS GmbH, Dortmund (DE)

(72) Inventor: Martin Gerhards, Hamburg (DE)

(73) Assignee: KHS GmbH, Dortmund (DE)

(21) Appl. No.: 17/781,619

(22) PCT Filed: Dec. 11, 2020
(86) PCT No.: PCT/EP2020/085675

§ 371 Date: Jun. 1, 2022

(30) Foreign Application Priority Data
Dec. 13, 2019 (DE) 10 2019 008 631.7

(51) Int. Cl. B29C 49/42; B29C 49/46; B29C 49/00

(52) U.S. Cl. CPC B29C 49/42822; B29C 49/46; B29C 49/006; B29C 2049/4697; B29C 2049/4679; B29L 2031/712

(57) ABSTRACT

The invention relates to a method and an plant for the production and treatment of sterile plastic containers, in which preforms made of a thermoplastic material are heated in the region of a heating section and then formed into containers by pneumatic or hydraulic pressure, and wherein the preforms or the containers or both are sterilized and pass through at least one low-germ zone which is surrounded by an enclosure, characterized in that the enclosure 2, 2′ has an outer housing 3, 3′ and an airlock chamber 4, 4′ through which treatment medium is extracted from the low-germ zone 1, 1′ and at the same time air is extracted from the outer environment of the outer housing 3, 3′.

The invention relates to a method and a plant for the production and treatment of sterile plastic containers, in which preforms made of a thermoplastic material are heated in the region of a heating section and then formed into containers by pneumatic or hydraulic pressure, and in which the preforms or the containers or both are sterilized and pass through at least one low-germ zone which is surrounded by an enclosure.

Plastic containers such as plastic bottles are predominantly manufactured using preforms made of a thermoplastic material such as PET (polyethylene terephthalate). The preforms are formed into the desired containers by pneumatic pressure (blowing pressure) or hydraulic pressure (in particular the pressure of a fluid to be filled).

However, before the charge is filled into the finished containers, the preforms and/or the finished containers must be sterilized. For this purpose, methods and devices are known with which the preforms or containers are treated with a sterilizing agent. In principle, all media suitable for killing microorganisms can be used as sterilization agent, in particular chemicals such as hydrogen peroxide, ozone, and chlorine dioxide. Sterilizing agents are often used in the form of sterilizing vapors (aerosols) at an elevated temperature of about 100-130° C. DE 10 2010 032 336, EP 1 941 913 and EP 2 394 950 describe methods and devices of this type.

Sterilization of plastic containers or preforms is usually performed as dry sterilization using hydrogen peroxide. However, chemicals such as ozone or chlorine dioxide are also suitable. In addition to dry sterilization, however, wet sterilization can also be considered, for example using peracetic acid.

If preforms are sterilized (preform sterilization), there is no need for additional sterilization of the finished plastic containers. Since the preform surface to be sterilized is smaller than the surface of the finished plastic containers to be sterilized, preform sterilization also reduces the consumption of sterilizing agent.

One advantage of dry sterilization is that a wide variety of bottle and closure types can be sterilized. For this purpose, a hydrogen peroxide aerosol is sprayed into the plastic containers or onto the closures, respectively, and removed again by supplying sterile hot air after condensation on the container or closure surface. The result is dry and sterile container and closure surfaces. The outer surfaces of the plastic containers can also be sterilized with a hydrogen peroxide aerosol.

The hydrogen peroxide aerosol can be introduced into any plastic bottle through a lance arranged in the plastic bottle and ending just below the bottle neck. The aerosol injection ensures that all areas in the bottle are exposed to hydrogen peroxide. This is done even in the case of ribbed, embossed, and rectangular bottles, as well as bottles with highly structured surfaces. Depending on the bottle shape and size, the hydrogen peroxide used for the sterilization process enters the non-preheated plastic bottle at a temperature of approx. 100° C., resulting in the formation of a continuous sterilization film inside the bottle. The sterilization of the outside of the plastic bottle is performed by spraying hydrogen peroxide directly onto the bottle wall. This is usually followed by residue-free or at least low-residue drying of hydrogen peroxide, for example within a drying carousel or other drying and/or heating devices. Alternatively, or additionally, a residue-free or at least low-residue removal of the hydrogen peroxide is also possible by the normal evaporation process during transport of the bottle.

EP 2 407 417 A1 also describes a production of sterile plastic bottles in which preforms and/or plastic bottles are treated with hydrogen peroxide and sterile air to sterilize the preforms and/or the plastic bottles. Corresponding treatment units are housed for this purpose in an isolator housing to provide a confined space for the treatment media.

As a result of sterilization, the sterilizing agents used may not only reach the preforms or finished plastic bottles to be sterilized but may also flow into plant parts where they are undesirable and can cause damage. It is even possible that the sterilizing agents could escape from the plant and reach open work areas. This could cause damage to the health of persons being directly exposed to the sterilization agents, then.

If plastic bottles or preforms are further treated after sterilization and fed to other treatment stations, such as a transfer station, a blow station or a fill station, care must also be taken there to ensure that any sterilizing agents introduced cannot escape the production hall. It is also important that no subsequent contamination of the plastic bottles occurs in the respective treatment stations. Therefore, aseptic conditions must prevail in the vicinity of the plastic bottles, i.e., penetration of microorganisms into those areas must be avoided.

In aseptic zones, it has therefore proved useful to have a treatment medium flow around the plastic bottles, such as sterile air. EP 2 407 417 A1 also provides for such a measure. For this purpose, a flow directed from top to bottom is generated in the isolator housing. The treatment media enter the isolator housing from above via supply air nozzles and exit again in the lower area via a collecting pipe. A permanent overpressure inside the isolator housing is intended to ensure that no external contamination occurs.

However, when treatment media (e.g., sterile air or sterilization medium) are extracted, it is possible that negative pressure may occur within individual regions of the respective treatment chambers, which may result in outside air being drawn in and, associated with this, the penetration of undesirable germs into the respective treatment chambers.

DE 10 2012 106 532 A1 describes a device for sterilizing closures with a treatment chamber to which two suction devices are connected. The sterilization medium introduced is extracted via these suction devices so that the treatment chamber is completely flushed with sterilization medium.

However, aspiration of sterilization medium also poses a contamination risk with this device. In addition, the possibility of sterilization medium escaping from the sterilization zone cannot be excluded, either.

It is therefore the object of the present invention to further reduce the risk of contamination that occurs during the manufacture and treatment of sterile plastic containers and to recover any sterilization media that may have escaped.

According to the invention, the task is solved by a method, which is characterized in that the enclosure has an outer housing and an airlock chamber, through which treatment medium from the low-germ zone and at the same time air from the outer environment of the outer housing are extracted.

For the purposes of the present invention, sterile plastic containers are those plastic containers or their preforms, respectively, which have been subjected to a sterilization treatment to kill microorganisms. Subsequently, the sterile plastic containers may pass through individual low-germ zones for further treatment, for example for filling under aseptic conditions. In a low-germ zone, unlike a sterilization zone, no sterilization treatment takes place; rather, a low-germ zone is designed to prevent transfer of microorganisms.

The plastic containers are in particular beverage containers such as plastic bottles. The further description of the invention may therefore refer to plastic bottles, without implying any limitation to those objects.

Treatment stations through which the preforms or finished plastic bottles pass for sterilization or afterwards must be kept germ-free. One or more low-germ zones are formed for this purpose. For example, a transfer station, a blow station, a sterilization station, or a fill station can be arranged within a low-germ zone.

The low-germ zone is characterized by a permanent introduction of sterile treatment medium, preferably sterile air. A positive displacement flow is generated for the sterile treatment medium, which prevents germs from entering the low-germ zone.

However, if treatment media are aspirated from a low-germ zone, contamination can occur, as shown in the introduction to this specification. According to the invention, those contaminations can be avoided if the treatment medium is extracted via an airlock chamber through which air from the outer environment of the outer housing passes at the same time. In this way, no negative pressure is generated in the low-germ zone, which would lead to an unwanted inflow of outside air. Outside air entering the airlock chamber does not pose a risk of contamination because there is negative pressure in the airlock chamber relative to the sterilization or low-germ zone, and the outside air entering the airlock chamber therefore cannot enter the sterilization or low-germ zone. If, against expectation, sterilization media escaped during production, sterilization media having entered the machine or having reached the outside would also be extracted.

However, the airlock chamber must have a suction opening which is positioned in a suitable manner such that treatment medium from the low-germ zone and at the same time air from the outer environment of the outer housing can be extracted via the airlock chamber. It has proved advantageous to open the airlock chamber downward or to provide it with one or more suitably positioned suction openings. In this case, the openings can be covered with filters to prevent contamination of the plant cladding. If the low-germ zone is placed on feet or other spacer elements, the desired extraction of treatment medium and outside air can be provided at the bottom of the low-germ zone.

The outer housing is configured and dimensioned such that is surrounds the low-germ zone and essential parts of the equipment housed therein. For example, a transfer device, a heating device for tempering preforms, a molding device with a blow wheel for forming the preforms into containers, a sterilization device and a fill device can be surrounded by the outer housing. Preferably, the outer housing is formed over the entire height of the machine and is essentially cuboidal.

The design of the outer housing offers the particular advantage that a so-called “room-in-room” concept may also be implemented. In this case, a sterilization zone is arranged inside the outer housing, the sterilization zone being as small as possible and being further protected from the surrounding machine room.

Treatment media according to the present invention are therefore sterilization media as well as sterile gaseous media, in particular air, which are introduced into a low-germ zone.

According to a preferred embodiment of the invention, the airlock chamber is formed between the outer housing and an inner housing, both surrounding the low-germ zone. In this case, the outer housing is spaced apart from the inner housing and spacing may be provided between all or only individual housing sides and/or housing ceilings. In a preferred manner, the airlock chamber is formed only between vertical sides of the outer and inner housings.

According to another embodiment of the invention, a channel at the lower end of the outer housing forms the airlock chamber. Such an airlock chamber is smaller than an airlock chamber extending over entire sides of the outer housing. It offers advantages over the double-walled variant because shut-off devices on the outer housing, such as doors, flaps, roller blinds and the like, do not have to be double-walled. The channel-shaped airlock chamber preferably runs along all inner walls at the lower end of the outer housing.

According to a further embodiment of the invention, the airlock chamber has a downwardly directed suction opening. In this case, the suction opening can extend over the entire length of a wall of the outer housing. Instead of a continuous suction opening, individual, smaller suction openings can also be distributed over the underside of the channel.

For the introduction of treatment media into the low-germ zone, it is provided that a gaseous treatment medium for sterilization is fed into the low-germ zone via a filter device. Particularly air may be considered as a gaseous treatment medium.

The filter device has at least one sterile filter so that germs (microorganisms) and solid particles to which microorganisms can adhere are kept out of the low-germ zone. HEPA filters (High Efficiency Particulate Air filters) and sterilizable cartridge filters can be used as filters.

The gaseous treatment medium is preferably introduced from above, i.e., through the ceiling of the outer housing and possibly through the ceiling of the inner housing, for example via connecting flanges, to generate the above-mentioned displacement flow. Depending on the size and geometry of the low-germ zone, one or more inlet openings can be provided, which may be distributed over the entire ceiling. Even the side walls of the outer and possibly the inner housing can have such inlet openings, particularly in the upper regions.

The object of the present invention is also solved by a plant characterized in that the enclosure comprises an outer housing and an airlock chamber with a suction opening positioned in such a way that, by a suction device connected to the airlock chamber, treatment medium can be extracted from the low-germ zone and, at the same time, air can be extracted from the outer environment of the outer housing through the airlock chamber.

For further description of the plant according to the invention as well as the intended extraction of treatment medium, reference is made to the above explanations.

According to a preferred embodiment of the invention, the enclosure is placed on an installation surface towards which the suction opening(s) of the airlock chamber is (are) directed. Feet or other distance elements ensure that the desired extraction of treatment medium and outside air can take place due to the distance to the installation surface. The installation surface is preferably the floor of the installation site. However, it is also conceivable that the installation surface is formed by a base plate, at least in certain regions.

In addition, one or more treatment stations for treating the preforms and/or the plastic containers can be accommodated in a low-germ zone. This means that an enclosure can surround one or more treatment stations, whereby it is possible that within only one enclosure individual treatment stations can in turn be separated from each other by airlocks or other passage systems.

Assigning only individual treatment stations to individual enclosures offers the advantage that the supply and discharge of treatment media can be controlled completely individually for the individual treatment zones.

Preferred embodiments of the invention are described below with reference to the drawings.

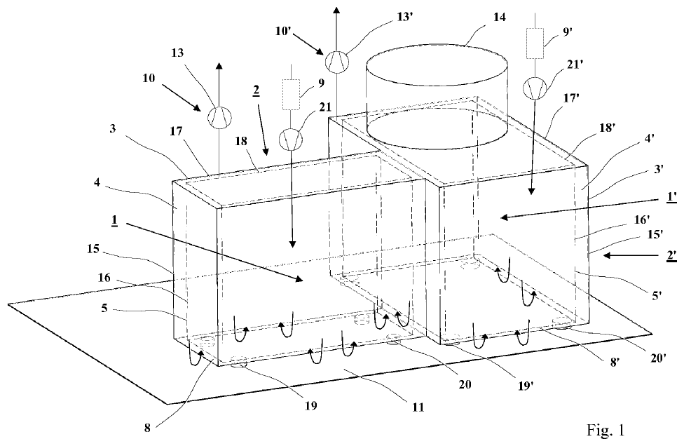

FIG. 1 shows a schematic view of two enclosures 2, 2′, each with an airlock chamber 4, 4′ between outer housing 3, 3′ and inner housing 5, 5′ and

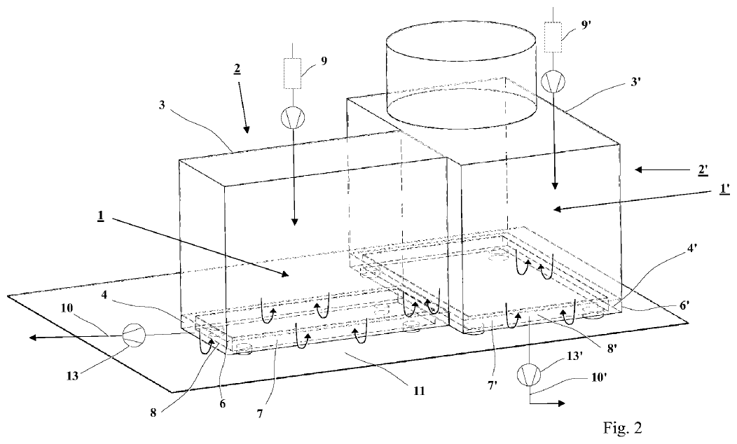

FIG. 2 shows a schematic view of two enclosures 2, 2′ each with an airlock chamber 4, 4′ in the form of a channel 7, 7′ at the lower end 6, 6′ of the outer enclosure 3, 3′.

Preferred embodiments of the invention are described below with reference to the drawings.

FIG. 1 shows two enclosures 2, 2′ each with an airlock chamber 4, 4′ between outer housing 3, 3′ and inner housing 5, 5′, which is formed here between all four vertical sides of outer and inner housing 3, 3′, 5, 5′. The enclosures 2, 2′ each surround a low-germ zone 1, 1′. The first low-germ zone 1 houses a sterilization device, and the second low-germ zone 1′ houses a fill device. Since, in principle, sterilization and fill equipment and their design is known, they are not described in detail.

After sterilization, the containers can be fed to a drying station having as known design. Such a drying station can be located in the same enclosure 2 as the sterilization equipment. The sterile containers can be transported from a drying station to the fill device. Depending on the equipment being accommodated in the low-germ zone 1, 1′, the enclosure 2, 2′ can have individual or several extensions 18 to prevent the total volume of the low-germ zone 1, 1′ from becoming too large overall.

The walls 15, 15′, 16, 16′ and ceilings 17, 17′, 18, 18′ of outer and inner housings 3, 3′, 5, 5′ may be made of metal or plastic, for example stainless steel or acrylic glass. In addition, the walls 15, 15′, 16, 16′ and ceilings 17, 17′, 18, 18′ may also incorporate shut-off devices such as doors, flaps, roller blinds and the like to allow access to machines and containers, for example for maintenance purposes or in the event of production interruptions.

In the embodiment shown, the entire enclosure 2, 2′ is placed on an installation surface 11 using feet 20, 20′, 21, 21′. Outer and inner housings 3, 3′, 5, 5′ are spaced from the installation surface 11 and form a circumferential airlock chamber 4, 4′ which extends upwards to the ceiling 17, 17′ of the outer housing 3, 3′ and is open downwards, towards the installation surface 11. This opening represents the suction opening 8, 8′, through which treatment medium from the low-germ zone 1, 1′ and at the same time air from the outer environment of the outer housing 3, 3′ can enter the airlock chamber 4, 4′ and can be extracted. The arrows illustrate the flow path. The installation surface 11 is preferably the floor of the installation location. It is also conceivable to use a base plate which at least partially forms the installation surface 11.

An extraction of treatment medium and air through the airlock chamber 4, 4′ takes place by a suction device 10, 10′, which has an extraction pump 13, 13′ and which is arranged at the upper end 12, 12′ of the airlock chamber 4, 4′.

FIG. 2 also shows two enclosures 2, 2′ each with an airlock chamber 4, 4′. In this embodiment example, the airlock chamber 4, 4′ is formed at the lower end 6, 6′ of the outer housing 3, 3′ by a channel 7, 7′. The channel 7, 7′ is closed towards the low-germ zone 1, 1′, and open towards the bottom, towards the installation surface 11. As in the embodiment example according to FIG. 1, treatment medium from the low-germ zone 1, 1′ and at the same time air from the outer environment of the outer housing 3, 3′ can enter the airlock chamber 4, 4′ through the suction opening 8, 8′ and can be extracted. A suction device 10, 10′ with extraction pump 13, 13′ is arranged laterally on the outer housing 3, 3′ or the channel 7, 7′. However, suction can be provided from the top of the channel 7, 7′ via appropriate suction lines through the enclosures 2, 2′.

In both embodiment examples according to FIGS. 1 and 2, a filter device 9, 9′ is provided, via which a gaseous treatment medium can be sterilized and subsequently conveyed into the low-germ zone 1, 1′ by a pump 21, 21′. Depending on the type of treatment device present in the low-germ zone 1, 1′, the sterile air can be introduced in a distributed manner via several inlet openings in the ceiling 17, 17′, 18, 18′ of the outer housing 3, 3′ or of the inner housing 5, 5′ to generate a displacement flow adapted to the respective treatment device.

### LIST OF REFERENCE SIGNS

1, 1′ low-germ zone

2, 2′ enclosure

3, 3′ outer housing

4, 4′ airlock room

5, 5′ inner housing

6, 6′ End

7, 7′ Channel

8, 8′ Suction opening

9, 9′ Filter device

10, 10′ Suction device

11 Installation surface

12, 12′ End

13, 13′ Extraction pump

14 Extension

15, 15′ Wall

16, 16′ Wall

17, 17′ Ceiling

18, 18′ Ceiling

19, 19′ Foot

20, 20′ Foot

21, 21′ Pump

1. A method for producing and treating sterile plastic containers, in which preforms made of a thermoplastic material are heated in the region of a heating section and then formed into containers by pneumatic or hydraulic pressure, and wherein the preforms or the containers or both are sterilized and pass through at least one low-germ zone which is surrounded by an enclosure, characterized in that the enclosure has an outer housing and an airlock chamber through which treatment medium is extracted from the low-germ zone and at the same time air is extracted from the outer environment of the outer housing.

2. The method according to claim 1, characterized in that the airlock chamber js formed between the outer housing and an inner housing of the enclosure.

3. The method according to claim 1, characterized in that the airlock chamber js formed at the lower end of the outer housing by a channel.

4. The method according to claim 1, characterized in that the airlock chamber has a downwardly directed suction opening.

5. The method according to claim 4, characterized in that a gaseous treatment medium is sterilized via a filter device and then passed into the low-germ zone.

6. A plant for the production and treatment of sterile plastic containers, in which preforms of a thermoplastic material are heated in the region of a heating section and then formed into containers by pneumatic or hydraulic pressure, and wherein the preforms or the containers or both are sterilized and pass through at least one low-germ zone which is surrounded by an enclosure, characterized in that the enclosure has an outer housing and an airlock chamber with a suction opening positioned in such a way that a suction device, which is connected to the airlock chamber, can extract treatment medium from the low-germ zone and at the same time the suction device can extract air from the outer environment of the outer housing through the airlock chamber.

7. The plant according to claim 6, characterized in that the airlock chamber js formed between the outer housing and an inner housing.

8. The plant according to claim 6, characterized in that the airlock chamber js formed at the lower end of the outer housing by a channel.

9. The plant according to claim 6, characterized in that the plant has a filter device via which a gaseous treatment medium is sterilized and then conveyed into the low-germ zone.

10. The plant according to claim 6, characterized in that the suction opening of the airlock chamber is directed downwards towards an installation surface (11).

11. The plant according to claim 6, characterized in that one or more treatment stations for treating the preforms and/or the plastic containers are accommodated in the low-germ zone.
